(19) United States
(12) Patent Application Publication
(10) Pub. No.: US 2008/0118302 A1
(43) Pub. Date: May 22, 2008

(54) VIBRATION-DECOUPLING ELEMENT

(76) Inventors: Rainer Sussenbach, Steinhagen (DE); Andreas Bertram, Herford (DE)

Correspondence Address: SEYFARTH SHAW LLP, 131 S. DEARBORN ST., SUITE 2400, CHICAGO, IL, 60603-5803, US

(21) Appl. No.: 11/940,828

(22) Filed: Nov. 15, 2007

(30) Foreign Application Priority Data
Nov. 22, 2006 (DE) 20 2006 017 798.1

(51) Int. Cl. F16C 11/06; F16B 39/284; F16B 13/04

(52) U.S. Cl. 403/227; 411/111; 411/25; 403/132

(57) ABSTRACT

A vibration-decoupling coupling element made of an elastically deformable female part and a male part is described. The female part has a fastening area, a decoupling area and a receiving area. The decoupling area is made up of a wall portion expanding away from the fastening area and shaped on the fastening area, a sleeve-shaped wall portion shaped on the receiving area and an annular shoulder wall portion connecting both these wall portions together. The male part has a fastening area and an insertion area. The insertion area is adjusted for the receiving area of the female part in order to form a plug-in connection in the assembled state of the coupling element.

### FIELD OF THE INVENTION

The invention relates to a vibration-decoupling coupling element, which is used to connect two components.

### BACKGROUND OF THE INVENTION

Numerous couplings, in particular plug-in couplings, are known in the state of the art for removably connecting two components. For example, the German utility model 202 16 836 shows a plug-in coupling made from an elastically deformable pan-shaped coupling part and a ball-shaped coupling part, which can be attached to the components to be connected and inserted into each other. The pan-shaped coupling part is made up of one ball pan, an annular intermediate wall shaped on it and an annular exterior wall shaped on it, which surrounds the ball pan with spacing and has a wave-like profile in a longitudinal section. The wave-like profile of the annular intermediate wall ensures a corresponding flexibility of the pan-shaped coupling part both in the radial as well as in the axial direction so that the pan-shaped coupling part can execute a vibration-decoupling compensating motion between both components in all directions.

This plug-in coupling has proven itself well in practice. However, a constructively simpler solution of this type of coupling would be desired for certain application purposes. It would also be advantageous if the natural frequency of the vibration system of these types of plug-in couplings as well as the tolerance compensation could be better controlled with respect to power and route of such plug-in couplings.

The object of the present invention is to provide a vibration-decoupling coupling element, which is particularly simple from a constructive point of view and can be used alone or in connection with conventional plug-in couplings.

### SUMMARY OF THE INVENTION

This object is solved in accordance with the invention by the vibration-decoupling coupling element defined in claim 1.

The coupling element designed according to the invention is made up of an elastically deformable female part and a male part, which can be inserted into each other along a central axis. The female part has a fastening area, a decoupling area and a receiving area. The decoupling area comprises a wall portion expanding away from the fastening area and shaped on the fastening area, a sleeve-shaped wall portion shaped on the receiving area and an annular shoulder wall portion connecting the wall portions together. The male part comprises a fastening area and an insertion area, of which the insertion area is adjusted to the receiving area of the female part in order to form a plug-in connection when the coupling element has been assembled.

The decoupling area of the female part is elastically deformable in both the axial and radial directions. It thus has vibration-decoupling/damping properties in all directions. Despite the low constructive effort, the coupling element is characterized by vibration- and noise-decoupling properties.

In another embodiment of the invention, it is provided that the fastening areas of the female part and the male part can be directly connected to two fixed components to be connected together so that the coupling element serves as a coupling between both components without other coupling parts. In this case, the coupling element designed according to the invention thereby forms a particularly cost-effective solution for a plug-in coupling for connecting two fixed components.

Alternatively, the invention offers the option that the coupling element is designed as a bolt-shaped coupling part of a plug-in coupling, which can be inserted into a pan-shaped coupling part of a plug-in coupling.

In this case, the coupling element designed according to the invention can be used in connection with a conventional plug-in coupling. For example, a plug-in coupling as disclosed in the initially named German utility model 202 16 836 is considered. However, all plug-in couplings, in which a bolt-shaped coupling part is inserted into a pan-shaped coupling part, are generally considered. See e.g. DE 198 36 108, DE 299 20 379, DE 201 07 949, DE 201 08 408, among others.

If the coupling element according to the invention is used in connection with a conventional plug-in coupling, the entire system has two separate, vibration-decoupling areas. This provides the option of influencing the natural frequency of the entire system in order to avoid undesired vibrations and achieving an increased tolerance compensation with respect to the power and route of the entire system.

The female part and the male part of the coupling element are preferably made of plastic, as will be explained in greater detail.

Further advantageous embodiments of the invention are defined in the dependent claims.

### BRIEF DESCRIPTION OF THE ACCOMPANYING DRAWINGS

Exemplary embodiments of the invention are explained in greater detail based on the drawings.

FIG. 1 shows a longitudinal section through a coupling element designed according to the invention;

FIG. 2 shows a perspective view of the coupling element in FIG. 1;

FIG. 3 shows a longitudinal section through the female part of the coupling element in FIGS. 1, 2;

FIG. 4 shows a top view of the female part in FIG. 3 from below;

FIG. 5 shows a side view of the male part of the coupling element in FIGS. 1, 2;

FIG. 6 shows a longitudinal section through a plug-in coupling, in which the coupling element of the FIGS. 1, 2 serves as a bolt-like coupling part, which sits in a pan-shaped coupling part of the plug-in coupling;

FIGS. 7 through 9 show different embodiments of the female part of the coupling element;

FIGS. 10 through 12 show different embodiments of the male part of the coupling element.

### DETAILED DESCRIPTION OF PREFERRED EMBODIMENTS OF THE INVENTION

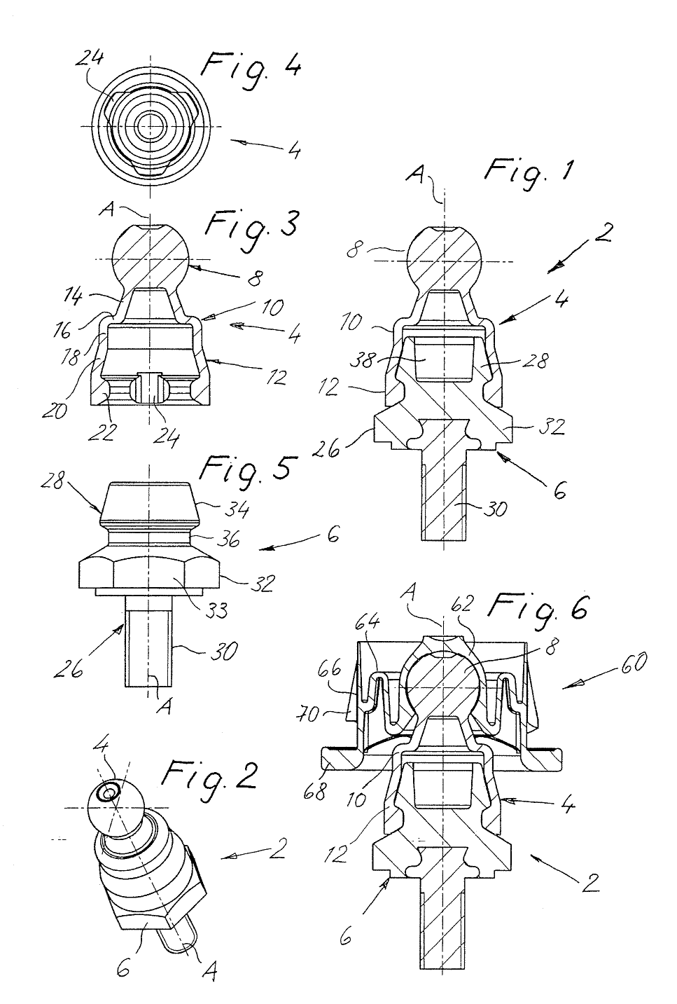

The vibration-decoupling/damping coupling element 2 shown in FIGS. 1 and 2 comprises a female part 4 and a male part 6, which can be inserted into each other along a central axis A.

FIGS. 3 and 4 show the female part 4. It is made up of a fastening area 8, a decoupling/damping area 10 and a receiving area 12. In the exemplary embodiment shown, the fastening area 8 is made up of a ball, which can be inserted into a ball pan of a plug-in coupling (FIG. 6). However, the fastening area can also be designed such that the female part 4 can be directly attached to a component to be connected (not shown). FIGS. 7 through 9, which will be covered in greater detail, show the options for this.

The decoupling/damping area 10 of the female part 4 is made up of a wall portion 14 widening away from the fastening area 8, a sleeve-like wall portion 18 and an annular shoulder wall portion 16, which connects both wall portions 14 and 18. The wall portion 14 is directly shaped on the ball of the fastening area 8 and has a conical shape in the exemplary embodiment shown. The wall portion 18 is directly shaped on the receiving area 12 of the fastening area 12 and has a cylindrical shape in the exemplary embodiment shown. The annular shoulder wall portion 16 runs mainly at a right angle to the central axis A and is connected by radii with the wall portions 14 and 18.

The receiving area 12 of the female part 4 is made up of a wall portion 20 extending conically from the wall portion 18, which passes into a cylindrical wall portion with an annular projection 22 projecting radially inwards on its free end. The annular projection 22 is provided at several (e.g. three) spots with recesses 24 distributed over the perimeter so that the receiving area 12 has a correspondingly decreased wall thickness in order to give the receiving area 12 a desired elasticity.

The conical wall portion 14 of the decoupling area 10 has a wall thickness that becomes smaller from the annular shoulder wall portion 16 in the direction of the fastening area 8. In the case of the functionality of the coupling element still to be described, this allows an even tension distribution over the axial length of the wall portion 14. The wall portions 16, 18 and 20 all have even wall thicknesses.

In addition to FIG. 1, please also refer to FIG. 5 for a description of the male part 6. The male part 6 comprises a fastening area 26 and an insertion area 28. In the exemplary embodiment shown, the fastening area 26 has a threaded portion 30 in the form of a metallic threaded bolt, which is embedded into a body portion 32 of the male part 6 on its one end. The body portion 32 is provided with a drive characteristic 33, which is a hexagon in the exemplary embodiment, but it can also be designed in any other manner.

The fastening area 6 is attached to one of the components to be connected (not shown) in that the metallic threaded portion 30 can be screwed into a corresponding threaded bore hole of the component. However, it should be pointed out that the fastening area can be designed in any other manner as long as it only allows one fastening of the male part 6 on the associated component. Different options for these fastening types show the FIGS. 10 through 12, which will be covered in greater detail.

The insertion area 28 of the male part 6 is directly shaped on the body portion 32 of the fastening portion 26 and consists of a body portion, which has a conical exterior surface 34, wherein an annular groove 36 is provided between the conical exterior surface 34 and the body portion 32. The conical exterior surface 34 and the annular groove 36 of the male part 6 are arranged with respect to their shape and dimensions on the receiving area 12, i.e. on the conical wall portion 20 and the annular projection 22 of the female part 4, such that their geometries mainly match, wherein however the diameters of the conical exterior surface 34 and the annular groove 36 are somewhat larger than the inner diameter of the conical wall portion 20 and the annual projection 22 of the receiving area 12 of the female part 4.

In the assembled state of the coupling element 2 (FIG. 1), the insertion area 28 of the male part 6 and the receiving area 12 of the female part 4 thereby form a plug-in connection, in which the conical wall portion 20 of the female part 4 and the conical exterior surface 34 of the male part 6 rest against each other in a press-fit manner and the annular project 22 of the female part 4 sits without play in the annular groove 36 of the male part 6

As can be seen in FIG. 1, the insertion area 28 of the male part 6 is provided with a central recess 38, which saves material.

As already mentioned, FIGS. 7 through 9 show different embodiments of the fastening area of the female part.

In the case of the embodiment shown in FIG. 7, the fastening area 8′ of the female part 4′ is provided with a threaded portion 40 in the shape of a threaded bushing, which consists of a metallic substance or a fiber-reinforced plastic. The threaded bushing cannot be moved in the axial direction and is arranged in a torque proof manner in a body portion 41 of the female part 8′ and is preferably coated with the material of the body portion 41 in an injection molding procedure. The threaded bushing serves to establish a screw connection with one of the components to be connected (not shown).

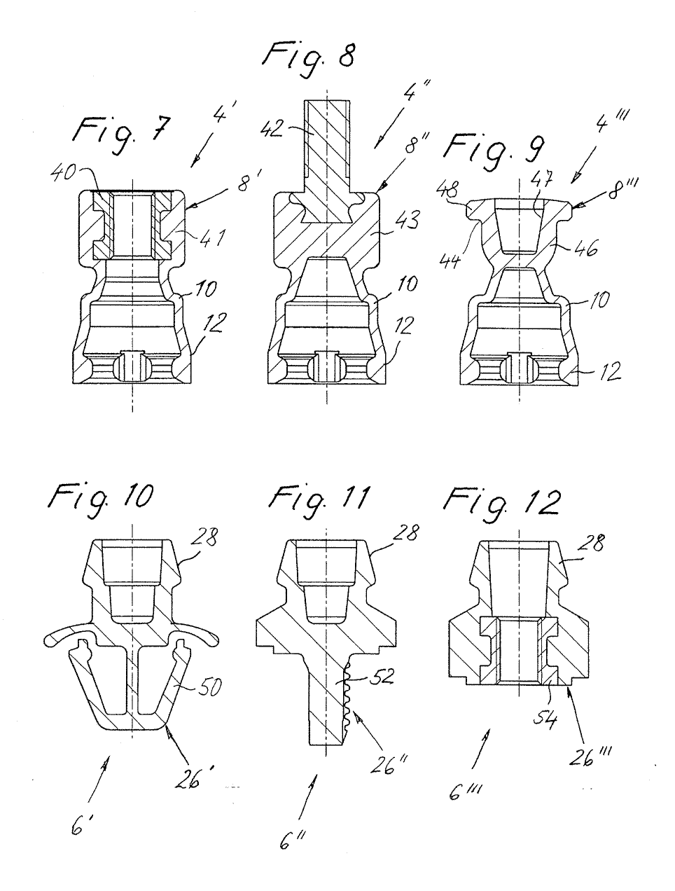

In the embodiment in FIG. 8, the fastening area 8″ of the male part 4″ comprises a threaded portion 42 in the form of a threaded bolt, which can also consist of a metallic material or a fiber-reinforced plastic and is embedded into the material of a body portion 43 of the female part 4″ in an injection-molding procedure. The threaded portion 42 serves in turn to establish a threaded connection with one of the components to be connected.

In the embodiment shown in FIG. 9, the fastening area 8′″ of the female part 4′″ is provided with a profiled portion 44, which has an annular projection 48 shaped on a body portion 46. The annular projection 48 can be inserted into a T-groove-like duct of the associated component (not shown), whereby a thread-free positive connection is created between the female part 4′″ and the associated component. A central recess 47 of the receiving area 8′″ can hereby serve as latch recess, into which a latch ball (not shown) of the associated component locks, in order to fix the receiving part 4′″ at a specified position on the associated component.

As already mentioned, numerous other fastening types, the details of which are not shown, are possible.

FIGS. 10 through 12 show different options for fastening the male part on the associated component.

Thus, in the embodiment of FIG. 10, the male part 6′ is provided with a fastening area 26′ in the form of a double-armed spring element 50, which makes a spring clip connection with the associated (plate-like) component.

In the embodiment in FIG. 11, the fastening area 26″ of the male part 6″ is made up of a threaded portion 52 in the form of a threaded bolt, which is shaped in one piece on the other male part 6″. As indicated on the right side of the threaded section 52, the threaded bolt is provided with a thread-grooving plastic thread, as described e.g. in DE 10 2004 021 484. However, any number of other thread types and shapes are also possible.

In the embodiment in FIG. 12, the fastening area 26′″ of the male part 6′″ is provided with a threaded bushing, which corresponds with the threaded bushing 40 in FIG. 7. At this point, we refer to the fact that the fastening types shown in FIGS. 7 through 9 can also be used in connection with the male part, as the fastening types shown in FIGS. 10 through 12 can also be used in connection with the female part.

The coupling element is made of plastic except for, if applicable, metallic inserts provided in the fastening areas. The female part is hereby made of a plastic with a very high elastic malleability and elasticity for the purposes of its decoupling and damping function, while the male part is made of a hard and mainly non-deformable plastic. The male part could generally be made of another hard material, in particular a metallic material.

The female part is preferably made of a thermoplastic elastomer on a polyester base, in particular polybutylene terephthalate (PBT) or polyethylene terephthalate (PET). These materials are elastically deformable despite a relatively high Shore hardness and have an excellent heat deformation resistance (150° C. and more). Moreover, they have a good chemical resistance. However, interlinked elastomers and rubber/caoutchouc can also be used. In the case of the embodiments in FIGS. 7 and 8, the threaded portions 40 and 42 are coated with this material.

The male part in FIGS. 1, 5 and 12 is made of a plastic from the group of technical thermoplasts, which is reinforced by fibers, in particular glass fibers, in order to give the male part the required high rigidity and hardness. The threaded portions 30 and 54 can also be made of plastic if permitted by the required mechanical rigidity. However, in the case of higher rigidity requirements, the threaded portions 30 and 54 are made of a metallic material, which is coated with the plastic of the other male part in an injection molding procedure.

In the case of the embodiment in FIG. 10, the male part 6′ is made of an impact-resistant plastic, which enables the clips function of the spring element 50. In order to increase its rigidity, the plastic can also be reinforced with a filler material, in particular with glass fibers.

In the case of the embodiment in FIG. 11, in which the fastening area 26″ is provided with a thread-grooving or thread-forming thread in accordance with DE 10 2004 021 484, the male part 6″ is advantageously made of a high-performance plastic, the temperature resistance, rigidity and stability of which is considerably larger than that of the plastic of the associated component (not shown). The high-performance plastic is preferably made of polyphtalamide (PPA-GF) or copolyamide based on polyphtalamide-GF or polyetherimide-GF (PEI-GF) or polyetherketone-GF (PEEK-GF) or polyamide—high glass filled or polyphthalamide—carbon fiber reinforced or polyphtalamide—carbon fiber reinforced and glass fiber reinforced or copolyamide based on polyphthalamide—carbon fiber reinforced or copolyamide based on polyphthalamide—carbon fiber reinforced and glass fiber reinforced or a duromer plastic.

The functionality of the coupling element will now be described. For this, it is first assumed that the coupling element is used as the coupling between two components to be connected (not shown), in which the fastening areas of the female part and the male part are fastened directly to the components to be connected. The fastening types shown in FIGS. 7 through 12 can hereby be used.

The coupling element 2 is preferably designed as a component (ZSB), which is put together to the components to be connected before assembly, in that the male part is inserted into the female part. For this, the female part 4 with the annular projection 22 is pushed in advance onto the insertion area 28 of the male part 6 until the annular projection 22 locks into the annular groove 36. The elasticity of the receiving area 12 of the female part 4 required for this is on one hand enabled by the properties of the plastic and on the other hand by the geometry of the receiving area 12 (recesses 24 in the annular projection 22). The coupling element 2 can now be transported and handled as a unit, before the female part is fastened on a component and the male part is fastened on the other component.

However, it is generally also possible to first fasten the female part and the male part on the associated components separately from each other and to only thereafter insert the male part and the female part into each other through a relative movement between the two components to be connected. In both cases, the female part and the male part are connected with each other in the assembled state through a play-free plug-in connection between the receiving area 12 and the insertion area 28, as was already described in detail above.

In the assembled state, the decoupling area 10 of the female part 4 enables vibration-decoupling compensating movements between the two components connected by the coupling element 2. In the case of an axial relative movement between both components and thus between the female part 4 and the male part 6, the annular shoulder portion 16 of the decoupling area 10 is deformed. In the case of an axial movement in the direction of pull, the annular shoulder wall portion 16 is deformed axially outwards and in the case of an axial relative movement in the direction of push, the annular shoulder wall portion 16 is deformed axially inwards.

In the case of relative movements between both components and thus between the female part 4 and the male part 6 in the radial direction, this leads to a corresponding deformation both of the conical wall portion 14 as well as the annular shoulder wall portion 16 of the decoupling area 10. The conical wall portion 14 hereby underlies a bending deformation, while the annular shoulder wall portion 16 is deformed according to the bending direction on opposite-lying sides in different axial directions.

It is understood that that these types of axial and radial compensating movements can superimpose each other. The decoupling area 10 of the female part 4 thus enables vibration-decoupling and dampening compensating movements between the components connected by the coupling element in all directions. The resistance to be overcome in the case of the compensating movements is determined by the properties of the plastic of the female part 4 to be used, which has a very high elastic deformation and a very high elasticity with a comparably large Shore hardness. The reset force for resetting the decoupling area 10 to its initial position is also determined by the material properties of the plastic.

In the case of the exemplary embodiments of the female part shown in the drawings, the decoupling area 10 is always designed the same. However, it is understood that the decoupling area can be adjusted with respect to its geometry, dimensions and wall thickness for special requirements with respect to the power and route of the vibration-decoupling compensating movements.

An important advantage of the present invention is that the coupling element 2 can be used not only as a coupling between two components to be connected, but also as a bolt-shaped coupling part of a plug-in connection. This insertion option is shown FIG. 6, in which the coupling element 2 is used in connection with a vibration-decoupling plug-in coupling, as disclosed in the initially named utility model DE 202 16 836.

The coupling element 2 works together with a pan-like coupling part 60, which is made up of a ball pan 62, an intermediate wall 64 with a waved profile and an exterior surface 66. A ring flange 68 and several projections 70 are shaped on the exterior wall 66, through which the pan-like coupling part 60 can be fastened on a plate-shaped component (not shown). Refer to the aforementioned utility model for other uniquenesses of the pan-shaped coupling part 6.

If the pan-shaped coupling part 60 is fastened on the one component and the coupling element 2 on the other component, the plug-in coupling can be inserted between both components through a relative movement, wherein the ball of the coupling element 2 locks into the ball pan 62 of the pan-like coupling part 60.

Both components are then connected by a coupling system, which has two separate decoupling areas (intermediate wall 64, decoupling area 10). The overall rigidity and the vibration-decoupling or -dampening properties of the overall system can hereby be influenced in a targeted manner. In particular, the natural frequency of the overall system can be set such that undesired resonance vibrations can be avoided in this manner. This also results in an increased tolerance area with respect to the power and route of the compensating movements, which gives greater design freedom to the constructor of these types coupling systems.

We claim:

1. Vibration-decoupling/damping coupling element comprising an elastically deformable female part and a male part, which can be inserted into the female part along a central axis, wherein
the female part has a fastening area, a decoupling/damping area and a receiving area, of which the decoupling area consists of a wall portion shaped on said fastening area and extending/widening in a direction opposite to the fastening area, a sleeve-shaped wall portion shaped on said receiving area, and an annular shoulder portion interconnecting said extending wall portion and said sleeve-shaped wall portion, and
said male part has a fastening area and an insertion area, of which the insertion area is matingly adjusted to the receiving area of the female part in order to form a plug-in connection when the coupling element has been assembled.

2. Coupling element according to claim 1, characterized in that said sleeve-shaped wall portion of the decoupling area is designed cylindrically.

3. Coupling element according to claim 1, characterized in that said annular shoulder portion of said decoupling area runs substantially rectangularly with respect to said central axis (A).

4. Coupling element according to claim 1, characterized in that said extending wall portion of said decoupling area is of conical shape.

5. Coupling element according to claim 1, characterized in that said extending wall portion of said decoupling area is of a wall thickness that becomes smaller towards the fastening area of the female part.

6. Coupling element according to claim 1, characterized in that said insertion area of said male part has a conical external surface and said receiving area of said female part has a wall portion with a conical internal surface which engages said conical external surface by an interference fit when the coupling element has been assembled.

7. Coupling element according to claim 1, characterized in that said insertion area of said male part includes an external annular groove and said receiving area of said female part has an internal annular projection which is received in said annular groove without play when the coupling element has been assembled.

8. Coupling element according to claim 7, characterized in that said annular projection is interrupted by a plurality of circumferentially spaced depressions in order to provide sufficient resiliency of the receiving area of said female part to enable the male part to be inserted into the female part.

9. Coupling element according to claim 1, characterized in that the fastening areas of the female part and the fastening area of the male part can be fastened directly on two rigid components to be connected together such that the coupling element serves as a coupling between both components without other coupling parts.

10. Coupling element according to claim 9, characterized in that the fastening area of the female part and/or the fastening area of the male part is provided with a threaded portion for being threadingly connected to an associated component.

11. Coupling element according to claim 9, characterized in that said fastening area of the female part and/or said fastening area of the male part is provided with a profiled portion for producing a thread-free positive connection with the associated component.

12. Coupling element according to claim 9, characterized in that said fastening area of the female part and/or said fastening area of the male part is provided with a snap-in portion for producing a snap connection with the associated component.

13. Coupling element according to claim 9, characterized in that said fastening area of said female part and/or said fastening area of said male part is provided with a spring element for producing a spring clip connection with the associated component.

14. Coupling element according to claim 1, characterized in that it is designed as a bolt-shaped coupling part of a plug-in coupling, which can be inserted into a pan-shaped coupling part of said plug-in coupling.

15. Coupling element according to claim 14, characterized in that the fastening area of said female part has a ball, which can be inserted into the pan-shaped coupling part of the plug-in coupling designed like a ball pan.

16. Coupling element according to claim 1, characterized in that said female part and said male part are made of a plastic material.

17. Coupling element according to claim 16, characterized in that said female part is made of a thermoplastic elastomer on a polyester base or an interlinked elastomer or a rubber or caoutchouc.

18. Coupling element according to claim 16, characterized in that said male part is made of a high-strength plastic material.

19. Coupling element according to claim 16, characterized in that said fastening area of the female part and/or said fastening area of the male part includes a metallic threaded part.
